(19) United States
(12) Patent Application Publication
(10) Pub. No.: US 2014/0309342 A1
(43) Pub. Date: Oct. 16, 2014

(54) MODELING PASTE COMPOSITION AND PREPARATION METHOD THEREOF

(71) Applicant: FOSHAN MASTER TOYS COMPANY LIMITED, Foshan City (CN)

(72) Inventor: Shi Qian GUO, Foshan City (CN)

(73) Assignee: FOSHAN MASTER TOYS COMPANY LIMITED, Foshan City (CN)

(21) Appl. No.: 13/862,213

(22) Filed: Apr. 12, 2013

(51) Int. Cl. C08L 29/04; C08J 3/215

(52) U.S. Cl. CPC C08L 29/04; C08J 3/215
USPC 524/55; 524/377; 524/291

(57) ABSTRACT

The present invention discloses a modeling paste composition which comprises 120-150 parts by weight of a first solvent; 50-100 parts by weight of a second solvent; 18-25 parts by weight of polyvinyl alcohol; 2-3 parts by weight of thickening agent; 1.5-3 parts by weight of preservative agent 10-15 parts by weight of glycerol; 5-10 parts by weight of borax; and 10-15 parts by weight of polystyrene beam. This invention also discloses a preparing method and use thereof. The modeling paste resulting from the above technical solution has the advantages of light-weight, non-fluidity, moisture retention for a long time.

### TECHNICAL FIELD

The present invention generally relates to the field of modeling paste, and more particularly, to a modeling paste composition which has good elasticity and can be used to manufacture toys and its preparation method.

### BACKGROUND OF THE INVENTION

The modeling paste is a new gum with characters of malleable and elastic, which can be used in a wide range of industry, such as toy industry. Any detailed description of manufacturing toy by using the modeling paste is not existed in prior art. Therefore, research and development of the modeling paste is necessary.

For example, U.S. Pat. No. 5,157,603 discloses an elastic modeling paste and method for preparing same. The modeling paste comprises a matrix which is a mixture of hydrophilic solid gel and a polyvinyl base cross-linked by di-borax, and expanded elastomeric beads dispersed throughout the said matrix. This document does not disclose the specific components of the modeling paste. And if using the modeling paste to form a toy, the toy does not have any color which would not be popular for children.

Therefore, there is still a need to improve the modeling paste in prior art so that on the basis of existing technology, a new modeling paste composition which would be popular for children can be produced by adding other substance or components into the existing modeling paste.

### SUMMARY OF THE INVENTION

This invention responds to the above need of a modeling paste composition, to provide a new modeling paste composition which has a better elasticity and can be deformed by simple pressure.

Another object of this invention is to provide a new modeling paste composition which has various color and can be formed various toys that is popular for children.

Another object of this invention is to provide a preparing method of the new modeling paste composition which is cost efficiency.

To achieve the above objects, the following technical solutions are adopted:

120-150 parts by weight of a first solvent;

50-100 parts by weight of a second solvent;

18-25 parts by weight of polyvinyl alcohol;

2-3 parts by weight of thickening agent;

1.5-3 parts by weight of preservative agent;

10-15 parts by weight of glycerol;

5-10 parts by weight of borax; and

10-15 parts by weight of polystyrene beam.

According to various embodiments of the present invention, the composition comprises:

130-140 parts by weight of a first solvent;

70-90 parts by weight of a second solvent;

20-22 parts by weight of polyvinyl alcohol;

2-3 parts by weight of thickening agent;

2-3 parts by weight of preservative agent;

12-15 parts by weight of glycerol;

6-8 parts by weight of borax; and

10-12 parts by weight of polystyrene beam.

According to one embodiment of the present invention, the first solvent is water at a temperature of 80-100° C.

According to one embodiment of the present invention, the second s is water at room temperature.

According to another embodiment of the present invention, the polyvinyl alcohol is commercially available.

According to various embodiments of the present invention, in order to change color of the modeling paste composition, 1-5 parts by weight of pigment are added in the composition.

According to another embodiment of the present invention, the thickening agent is selected from the group consisting of guargum, xanthan gum or a mixture thereof.

According to another embodiment of the present invention, the preservative agent is selected from the group consisting of methyl p-hydroxybenzoate, propyl p-hydroxybenzoate, nipagin complex ester or a mixture thereof.

According to another embodiment of the present invention, the polystyrene beam has a diameter of 0.5 mm-1.5 mm.

According to another aspect of the invention, this invention provides a method for preparing the modeling paste composition, which comprises the following steps:

heating a first solvent to 80-100° C. in a reaction vessel, then agitating the first solvent;

adding slowly polyvinyl alcohol into the vessel under agitation until fully dissolving the polyvinyl alcohol, and cooling it to room temperature over night to obtain a first mixture;

under agitation, mixing a first thickening agent and a preservative agent, then adding glycerol to obtain a second mixture;

under agitation, adding a second thickening agent into a second solvent o obtain a third mixture;

adding the third mixture into the second mixture to obtain a fourth mixture;

under agitation, adding the fourth mixture into the first mixture to obtain fifth mixture;

adding borax solution which is obtained by totally solvating borax in the first solvent at the temperature of 80-100° C. into the fifth mixture, and agitating clockwise and counter- clockwise respectively;

then adding polystyrene beam into the fifth mixture under agitation to obtain the modeling paste composition.

According to one embodiment of the invention, the method further comprises a step of adding pigment after adding the borax into the fifth mixture, and agitating to fully dissolve the pigment.

According to another embodiment of the invention, the agitation is performed by an agitator at a speed of 15-35 rpm.

According to another embodiment of the invention, the first thickening agent is xanthan gum, and the second thickening agent is guargum.

According to another embodiment of the invention, the preservative agent is selected from the group consisting of methyl p-hydroxybenzoate, propyl p-hydroxybenzoate, nipagin complex ester or a mixture thereof.

According to another embodiment of the invention, the clockwise agitation and counter-clockwise agitation are performed for 4-10 minutes respectively.

According to another embodiment of the invention, the first solvent and the second solvent are water respectively.

According to another embodiment of the invention, the polystyrene beam has a diameter of 0.5 mm-1.5 mm.

According to another aspect of the invention, this invention further provides use of the modeling paste composition in manufacture of toys.

The modeling paste resulting from the above technical solution has the advantages of light-weight, non-fluidity and moisture retention for a long time. This paste can be deformed by a simple pressure, and does not flow. In addition, the method of the invention is cost-efficiency which lower cost of manufacturers. And the more important point is adding the preservative agent into the modeling paste, which can guarantee the health of the children.

### DETAILED DESCRIPTION OF THE INVENTION

The detail of the invention will be explained below. The description and explanatory embodiments herein are merely used to set forth the present invention, not to limit the invention.

According to the invention, the modeling paste composition of the invention comprises 120-150 parts by weight of a first solvent; 50-100 parts by weight of a second solvent; 18-25 parts by weight of polyvinyl alcohol; 2-3 parts by weight of thickening agent 1.5-3 parts by weight of preservative agent 10-15 parts by weight of glycerol: 5-10 parts by weight of borax; and 10-15 parts by weight of polystyrene beam.

According to various embodiments of the present invention, the composition further comprises 130-140 parts by weight of a first solvent; 70-90 parts by weight of a second solvent; 20-22 parts by weight of polyvinyl alcohol; 2-3 parts by weight of thickening agent; 2-3 parts by weight of preservative agent; 12-15 parts by weight of glycerol; 6-8 parts by weight of borax; and 10-12 parts by weight of polystyrene beam.

According to one embodiment of the present invention, the first solvent is water at a temperature of 80-100° C., and the second solvent is water at room temperature.

According to another embodiment of the present invention, the polyvinyl alcohol is commercially available. In one embodiment of the invention, the polyvinyl alcohol is polyvinyl alcohol 205 which has a viscosity of 15-25 cps, or polyvinyl alcohol 204 which has a viscosity of 45-50 cps.

According to various embodiments of the present invention, in order to change color of the modeling paste composition, 1-5 parts by weight of pigment are added in the composition. Preferably, 2-4 parts by weight of pigment axe added in the composition. Since the pigment is non-toxic and can change color of the invention, various colors can be obtained if using different kinds of pigments.

According to another embodiment of the present invention, the thickening agent is selected from the group consisting of guargum, xanthan gum or a mixture thereof.

According to another embodiment of the present invention, the preservative agent is selected from the group consisting of methyl p-hydroxybenzoate, propyl p-hydroxybenzoate, nipagin complex ester or a mixture thereof. Adding preservative agents can prevent bacterial from breeding, and thus can lengthen the lifetime of the product. If desired, any combination of the above preservative agents can be used in the method in order to gain different preservative effects.

The glycerol of the invention plays a role of moisture retention and plasticization. The borax of the invention plays a role of crossing-linking and corrosion protection.

According to another embodiment of the present invention, the polystyrene beam has a diameter of 0.5 mm-1.5 mm. Preferably, the polystyrene beam has a diameter of 0.5 min-0.9 mm. More preferably, the polystyrene beam has a diameter of 0.5 mm-0.8 mm.

According to another aspect of the invention, this invention provides a method for preparing the modeling paste composition, which comprises the following steps:

heating a first solvent to 80-100° C. in a reaction vessel, then agitating the first solvent;

adding slowly polyvinyl alcohol into the vessel under agitation until fully dissolving the polyvinyl alcohol, and cooling it to room temperature over night to obtain a first mixture;

under agitation, mixing a first thickening agent and a preservative agent, then adding glycerol to obtain a second mixture;

under agitation, adding a second thickening agent into a second solvent to obtain a third mixture;

adding the third mixture into the second mixture to obtain a fourth mixture;

under agitation, adding the fourth mixture into the first mixture to obtain fifth mixture;

adding borax solution which is obtained by totally solvating borax in the first solvent at the temperature of 80-100° C. into the fifth mixture, and agitating clockwise and counter-clockwise respectively;

then adding polystyrene beam under agitation to obtain the modeling paste composition.

According to one embodiment of the invention, the method further comprises a step of adding pigment after adding the borax into the fifth mixture, and agitating to fully dissolve the pigment.

According to another embodiment of the invention, the agitation is performed by an agitator at a speed of 15-35 rpm.

According to another embodiment of the invention, the first thickening agent is xanthan gum, and the second thickening agent is guargum.

According to another embodiment of the invention, the preservative agent is selected from the group consisting of methyl p-hydroxybenzoate, propyl p-hydroxybenzoate, nipagin complex ester or a mixture thereof.

According to another embodiment of the invention, the clockwise agitation and counterclockwise agitation are performed for 4-10 minutes respectively.

According to another embodiment of the invention, the first solvent and the second solvent are water respectively.

According to another embodiment of the invention, the polystyrene beam has a diameter of 0.5 mm-1.5 mm. Preferably, the polystyrene beam has a diameter of 0.5 mm-0.9 mm. More preferably, the polystyrene beam has a diameter of 0.5 mm-0.8 mm.

According to another aspect of the invention, this invention provides use of the modeling paste composition in manufacture of toys.

Various examples are described below to set forth the instant invention in detail. In this invention, all the start materials are commercially available in the market, such as glycerol, pigment and polystyrene beam are commercially available.

In view of good property of the modeling paste composition of the invention, different kinds of toys can be further manufactured, which can not only develop intelligence of the children, but also guarantee the health of the children.

### Example 1

heating water in a reaction vessel to 80° C., then agitating water at a speed of 20 rpm; adding slowly 180 g polyvinyl alcohol (PVA205 130 g, and PVA204 50 g) into the water under agitation for 30 minutes until fully dissolving the polyvinyl alcohol, and cooling it to room temperature over night to obtain a first mixture;

mixing 10 g methyl p-hydroxybenzoate, 10 g propyl p-hydroxybenzoate and 15 g xanthan gum, then adding 150 g glycerol under agitation at a speed of 20 rpm to obtain a second mixture;

under agitation solvating 6 g guargum in the 600 g water at room temperature to obtain a third mixture and adding the third mixture into the second mixture to obtain a fourth mixture;

under agitation at a speed of 20 rpm, adding the fourth mixture into the first mixture to obtain a fifth mixture;

adding borax solution which is obtained by totally solvating 45 g borax in 300 g water at the temperature of 90° C. into the fifth mixture, and then agitating the resultant mixture at a speed of 20 rpm in which agitating clockwise is done for 5 minutes, agitating counter-clockwise is done for 5 minutes and agitating clockwise is done for another 5 minutes;

adding 10 g pigments into the resultant mixture and agitating for 10 minutes at a speed of 20 rpm;

then adding 100 g polystyrene beam having a diameter of 0.5 mm under agitation in the resultant mixture to obtain the modeling paste composition.

In order to obtain the nature of the modeling paste composition above, tests are performed as below:

1) Viscosity Test Result:

the viscosity of the above modeling paste composition is tested by using conventional technology and device. And the tested viscosity is 27.82 cps by using conventional viscosity instrument;

2) Elasticity Test Result:

The above modeling paste composition is pressed into a ball. The ball is fallen freely under the influence of force of gravity to the floor, and the first rebounding height from the floor is measured to be 26.50 cm.

### Example 2

heating water in a reaction vessel to 100° C., then agitating water at a speed of 35 rpm; adding slowly 250 g polyvinyl alcohol (PVA205 150 g, and PVA204 100 g) into the water under agitation for 30 minutes until fully dissolving the polyvinyl alcohol, and cooling it to room temperature over night to obtain a first mixture;

mixing 5 g methyl p-hydroxybenzoate, 5 g nipagin complex ester and 10 g xanthan gum, then adding 120 g glycerol under agitation at a speed of 35 rpm to obtain a second mixture;

under agitation solvating 15 g guargum in the 600 g water at room temperature to obtain a third mixture and adding the third mixture into the second mixture to obtain a fourth mixture;

under agitation at a speed of 35 rpm, adding the fourth mixture into the first mixture to obtain a fifth mixture;

adding borax solution which is obtained by totally solvating 100 g borax in 300 g water at the temperature of 90° C. into the fifth mixture, and then agitating the resultant mixture at a speed of 35 rpm in which agitating clockwise is done for 8 minutes, agitating counter-clockwise is done for 8 minutes and agitating clockwise is done for another 8 minutes;

adding 50 g pigments into the resultant mixture and agitating for 15 minutes at a speed of 35 rpm;

then adding 150 g polystyrene beam having a diameter of 0.8 mm under agitation in the resultant mixture to obtain the modeling paste composition.

In order to obtain the nature of the modeling paste composition above, tests are performed as below:

1) Viscosity Result:

the viscosity of the above modeling paste composition is tested by using conventional technology and device. And the tested viscosity is 28.56 cps by using conventional viscosity instrument;

2) Elasticity Result:

The above modeling paste composition is pressed into a ball. The ball is fallen freely under the influence of force of gravity to the floor, and the first rebounding height from the floor is measured to be 27.45 cm.

### Example 3

heating water in a reaction vessel to 90° C., then agitating water at a speed of 15 rpm; adding slowly 200 g polyvinyl alcohol (PVA205 120 g, and PVA204 80 g) into the water under agitation for 30 minutes until fully dissolving the polyvinyl alcohol, and cooling it to room temperature over night to obtain a first mixture;

mixing 8 g methyl p-hydroxybenzoate, 8 g propyl p-hydroxybenzoate and 12 g xanthan gum, then adding 100 g glycerol under agitation at a speed of 15 rpm to obtain a second mixture;

under agitation solvating 12 g guargum in the 600 g water at room temperature to obtain a third mixture and adding the third mixture into the second mixture to obtain a fourth mixture;

under agitation at a speed of 15 rpm, adding the fourth mixture into the first mixture to obtain a fifth mixture;

adding borax solution which is obtained by totally solvating 50 g borax in 300 g water at the temperature of 90° C. into the fifth mixture, and then agitating the resultant mixture at a speed of 15 rpm in which agitating clockwise is done for 4 minutes, agitating counter-clockwise is done for 4 minutes and agitating clockwise is done for another 4 minutes;

adding 50 g pigments into the resultant mixture and agitating for 12 minutes at a speed of 35 rpm,

then adding 120 g polystyrene beam having a diameter of 0.9 mm under agitation in the resultant mixture to obtain the modeling paste composition.

In order to obtain the nature of the modeling paste composition above, tests are performed as below:

1) Viscosity Result:

the viscosity of the above modeling paste composition is tested by using conventional technology and device. And the tested viscosity is 26.84 cps by using conventional viscosity instrument;

2) Elasticity Result:

The above modeling paste composition is pressed into a ball. The ball is fallen freely under the influence of force of gravity to the floor, and the first rebounding height from the floor is measured to be 28.30 cm.

### Example 4

heating water in a reaction vessel to 95° C., then agitating water at a speed of 25 rpm; adding slowly 220 g polyvinyl alcohol (PVA205 130 g, and PVA204 90 g) into the water under agitation for 30 minutes until fully dissolving the polyvinyl alcohol, and cooling it to room temperature over night to obtain a first mixture;

mixing 10 g methyl p-hydroxybenzoate, 8 g propyl p-hydroxybenzoate and 15 g xanthan gum, then adding 130 g glycerol under agitation at a speed of 25 rpm to obtain a second mixture;

under agitation solvating 13 g guargum in the 600 g water at room temperature to obtain a third mixture and adding the third mixture into the second mixture to obtain a fourth mixture;

under agitation at a speed of 25 rpm, adding the fourth mixture into the first mixture to obtain a fifth mixture;

adding borax solution which is obtained by totally solvating 70 g borax in 300 g water at the temperature of 90° C. into the fifth mixture, and then agitating the resultant mixture at a speed of 25 rpm in which agitating clockwise is done for 6 minutes, agitating counter-clockwise is done for 6 minutes and agitating clockwise is done for another 6 minutes;

adding 30 g pigments into the resultant mixture and agitating for 15 minutes at speed of 35 rpm;

then adding 130 g polystyrene beam having a diameter of 1.5 mm under agitation in the resultant mixture to obtain the modeling paste composition.

In order to obtain the nature of the modeling paste composition above, tests are performed as below:

1) Viscosity Result:

the viscosity of the above modeling paste composition is tested by using conventional technology and device. And the tested viscosity is 29.56 cps by using conventional viscosity instrument;

2) Elasticity Result:

The above modeling paste composition is pressed into a ball. The ball is fallen freely under the influence of force of gravity to the floor, and the first rebounding height from the floor is measured to be 28.75 cm.

### Example 5

heating water in a reaction vessel to 85° C., then agitating water at a speed of 25 rpm;

adding slowly 190 g polyvinyl alcohol (PVA205 140 g, and PVA204 50 g) into the water under agitation for 30 minutes until fully dissolving the polyvinyl alcohol, and cooling it to room temperature over night to obtain a first mixture;

mixing 9 g methyl p-hydroxybenzoate, 9 g propyl p-hydroxybenzoate and 13 g xanthan gum, then adding 140 g glycerol under agitation at a speed of 35 rpm to obtain a second mixture;

under agitation solvating 7 g guargum in the 600 g water at room temperature to obtain a third mixture and adding the third mixture into the second mixture to Obtain a fourth mixture;

under agitation at a speed of 25 rpm, adding the fourth mixture into the first mixture to obtain a fifth mixture;

adding borax solution which is obtained by totally solvating 85 g, borax in 300 g water at the temperature of 85° C. into the fifth mixture, and then agitating the resultant mixture at a speed of 25 rpm in which agitating clockwise is done for 6 minutes, agitating counter-clockwise is done for 6 minutes and agitating clockwise is done for another 6 minutes;

adding 35 g pigments into the resultant mixture and agitating for 10 minutes at speed of 35 rpm;

then adding 120 g polystyrene beam having a diameter of 1.5 mm under agitation in the resultant mixture to obtain the modeling paste composition.

In order to obtain the nature of the modeling paste composition above, tests are performed as below:

1) Viscosity Result:

the viscosity of the above modeling paste composition is tested by using conventional technology and device. And the tested viscosity is 28.25 cps by using conventional viscosity instrument;

2) Elasticity Result:

The above modeling paste composition is pressed into a ball. The ball is fallen freely under the influence of force of gravity to the floor, and the first rebounding height from the floor is measured to be 29.35 cm.

In the above examples, all the ingredients added must be fully dissolved in the solvent such as water. So in every step of the method of the invention, tests should be conducted in order to check whether the ingredients are fully dissolved. Generally, conventional method can be adopted in this invention. For example, wood rod or glass rod can be used to insert into the mixture, if no granules are stuck to the wood rod or the glass rod, the ingredients are showed to be fully dissolved, while any granules are stuck to the wood rod or the glass rod, the ingredients are showed to be not fully dissolved and agitation should be continued until all the ingredients are tested to be fully dissolved.

In the above examples, the resultant modeling paste composition has a good property and can be further made to form a children's toy which is harmless to children.

While a particular embodiment of the invention has been described, it will be obvious to those skilled in the art that changes and modifications can be made without departing from the true spirit and scope of the invention. It should be appreciated that all the embodiments of the present invention described above are illustrative only, and all the changes and modifications made by those skilled in the art are covered by the appended claims.

1. A modeling paste composition comprising:
120-150 parts by weight of a first solvent;
50-100 parts by weight of a second solvent;
18-25 parts by weight of polyvinyl alcohol;
2-3 parts by weight of thickening agent;
1.5-3 parts by weight of preservative agent;
10-15 parts by weight of glycerol;
5-10 parts by weight of borax; and
10-15 parts by weight of polystyrene beam.

2. The modeling paste composition according to claim 1, wherein the composition comprises:
130-140 parts by weight of a first solvent;
70-90 parts by weight of a second solvent;
20-22 parts by weight of polyvinyl alcohol;
2-3 parts by weight of thickening agent;
2-3 parts by weight of preservative agent;
12-15 parts by weight of glycerol;
6-8 parts by weight of borax; and
10-12 parts by weight of polystyrene beam.

3. The modeling paste composition according to claim 1, wherein the composition further comprises 1-5 parts by weight of pigment.

4. The modeling paste composition according to claim 1, wherein the thickening agent is selected from the group consisting of guargum, xanthan gum or a mixture thereof.

5. The modeling paste composition according to claim 1, wherein the preservative agent is selected from the group consisting of methyl p-hydroxybenzoate, propyl p-hydroxybenzoate, nipagin complex ester or a mixture thereof.

6. The modeling paste composition according to claim 1, wherein the polystyrene beam has a diameter of 0.5 mm-1.5 mm.

7. The modeling paste composition according to claim 1, wherein the first solvent is water at a temperature of 80-100° C., and the second solvent is water at room temperature.

8. A preparation method of modeling paste composition, wherein the method comprises the following steps:
heating a first solvent to 80-100° C. in a reaction vessel, then agitating the first solvent;
adding slowly polyvinyl alcohol into the vessel under agitation to fully dissolve the polyvinyl alcohol, and cooling it to room temperature over night to obtain a first mixture;
under agitation, mixing a first thickening agent and a preservative agent, then adding glycerol to obtain a second mixture;
under agitation, adding a second thickening agent into a second solvent to obtain a third mixture;
adding the third mixture into the second mixture to obtain a fourth mixture;
under agitation, adding the fourth mixture into the first mixture to obtain fifth mixture;
adding borax solution which is obtained by totally solvating borax in the first solvent at the temperature of 80-100° C. into the fifth mixture, and agitating clockwise and counter-clockwise respectively;
then adding polystyrene beam into the fifth mixture under agitation to obtain the modeling paste composition.

9. The preparation method of modeling paste composition according to claim 8, wherein the method further comprises a step of adding pigment after adding the borax solution into the fifth mixture, and agitating to fully dissolve the pigment.

10. The preparation method of modeling paste composition according to claim 8, wherein the agitation is performed by an agitator at a speed of 15-35 rpm.

11. The preparation method of modeling paste composition according to claim 8, wherein the first thickening agent is xanthan gum, and the second thickening agent is guargum.

12. The preparation method of modeling paste composition according to claim 8, wherein the preservative agent is selected from the group consisting of methyl p-hydroxybenzoate, propyl p-hydroxybenzoate, nipagin complex ester or a mixture thereof.

13. The preparation method of modeling paste composition according to claim 8, wherein the clockwise agitation and counter-clockwise agitation are performed for 4-10 minutes respectively.

14. The preparation method of modeling paste composition according to claim 8, the first solvent and the second solvent are water respectively.

15. The preparation method of modeling paste composition according to claim 8, wherein the polystyrene beam has a diameter of 0.5 mm-1.5 mm.

16. Use of the modeling paste composition according to claim 1 in manufacture of toys.

17. The modeling paste composition according to claim 2, wherein the composition further comprises 1-5 parts by weight of pigment.

18. The modeling paste composition according to claim 2, wherein the thickening agent is selected from the group consisting of guargum, xanthan gum or a mixture thereof.

19. The modeling paste composition according to claim 2, wherein the preservative agent is selected from the group consisting of methyl p-hydroxybenzoate, propyl p-hydroxybenzoate, nipagin complex ester or a mixture thereof.

20. The modeling paste composition according to claim 2, wherein the polystyrene beam has a diameter of 0.5 mm-1.5 mm.

21. The modeling paste composition according to claim 2, wherein the first solvent is water at a temperature of 80-100° C., and the second solvent is water at room temperature.

22. Use of the modeling paste composition according to claim 2 in manufacture of toys.
